(19) United States
(12) Patent Application Publication
(10) Pub. No.: US 2015/0093718 A1
(43) Pub. Date: Apr. 2, 2015

(54) HOUSING FOR DENTAL IMPLANTS

(71) Applicant: 3M INNOVATIVE PROPERTIES COMPANY, SAINT PAUL, MN (US)

(72) Inventors: Greg E. Schrank, Bloomington, MN (US); Sam L. Lintereur, Minneapolis, MN (US); Steven J. Maxa, Lakeville, MN (US); Kimberly A. Prenosil, Saint Paul, MN (US)

(21) Appl. No.: 14/385,373

(22) PCT Filed: Mar. 15, 2013
(86) PCT No.: PCT/US2013/032235

§ 371 Date: Sep. 15, 2014

Related U.S. Application Data
(60) Provisional application No. 61/614,998, filed on Mar. 23, 2012.

(51) Int. Cl. A61C 8/00; A61C 13/00; A61C 13/265

(52) U.S. Cl. CPC A61C 8/0065; A61C 13/2656; A61C 8/0062; A61C 13/0006
USPC 433/199.1; 433/201.1; 29/896.1

(57) ABSTRACT

Described herein is a housing that releasably connects a dental prosthetic device, such as a full or partial denture, to a dental implant. The housing is at least partially constructed of a resilient material, at least providing the denture with machinability relative to prior art metal housings. A method of manufacturing a housing for a dental implant and a method of retrofitting a housing for a dental implant are described.

This application claims priority to U.S. Provisional Patent Application No. 61/614,998, filed on Mar. 23, 2012, which is incorporated by reference in its entirety herein.

### BACKGROUND

Denture stabilization can be achieved with minimally-invasive, small-diameter dental implants. The procedure is relatively simple and gaining popularity amongst dental practitioners and their patients.

A key component of Mini Dental Implant (MDI) systems for denture stabilization is the metal housing and integral o-ring (see, e.g., U.S. Pat. No. 6,716,030 and US2006/0275735, both of which are incorporated by reference herein in their entirety). The housing provides a detachable link between the denture and the implant. Depending on the patients' needs, the housings are provided in different sizes. Each model has a characteristic retention force that is generated by an elastomeric o-ring. In properly functioning systems, geometric clearance is maintained between the housing and the implant and connection between the housing and the implant is solely through the o-ring. This provides a degree of mechanical isolation in which the chewing forces are transferred through the denture to the soft tissue (gums) rather than directly to the implant.

### SUMMARY

The present disclosure relates to a housing that can be used to retain a dental implant, methods of manufacturing the housing, and methods of retrofitting the housing. One feature and advantage of the housing of the present disclosure is that a portion of the housing of the present disclosure can be machined in-situ to create additional clearance between the implant and housing to avoid the undesirable contact between the housing and the head of the implant.

Some aspects of the present disclosure provide a housing for a dental implant. The housing can include an upper portion and a metal lower portion adapted to retain a retentive insert. The upper portion of the housing can be made of a polymeric material and can be machined in-situ.

Some aspects of the present disclosure provide a method of manufacturing a housing for a dental implant. The method can include providing a polymeric material; providing a metal lower portion of the housing; and affixing the polymeric material to the metal lower portion.

Some aspects of the present disclosure provide a method of retrofitting a housing for a dental implant. The method can include using a dental tool to machine out a portion of the housing as needed to provide additional clearance between the housing and the implant.

Other features and aspects of the present disclosure will become apparent by consideration of the detailed description and accompanying drawings.

### BRIEF DESCRIPTION OF THE DRAWINGS

FIG. 1a is the perspective view of a housing for a dental implant.

FIG. 1b is the cross-section view of a housing for a dental implant.

FIG. 2 is the cross-section view of one embodiment of the housing for a dental implant.

FIG. 3 is the cross-section view of the denture/housing assembly with the dental implant installed.

FIG. 4 is the cross-section view of the denture/housing assembly with the dental implant removed.

FIG. 5 is the cross-section view of the denture/housing assembly showing a dental bur being used to machine the housing in-situ.

FIG. 6 is the cross-section view of the denture/housing assembly with the dental implant after in-situ machining.

FIGS. 7a and 7b are the perspective views of an exemplary manufacturing process for the housing.

### DETAILED DESCRIPTION

Before any embodiments of the present disclosure are explained in detail, it is understood that the invention is not limited in its application to the details of use, construction, and the arrangement of components set forth in the following description or illustrated in the following drawings. The invention is capable of other embodiments and of being practiced or of being carried out in various ways that will become apparent to a person of ordinary skill in the art upon herein is for the purpose of description and should not be regarded as limiting. The use of “including,” “comprising,” or “having” and variations thereof herein is meant to encompass the items listed thereafter and equivalents thereof as well as additional items. It is understood that other embodiments may be utilized and structural or logical changes may be made without departing from the scope of the present disclosure.

Described herein is a housing that releasably connects a dental prosthetic device, such as a full or partial denture, to a dental implant. The housing has at least two innovative features: selective cushioning and improved machinability. These features provide operational flexibility to the dentist and higher probability of case success for the patient.

The housing design described herein features the use of a resilient non-metallic material (e.g., polymeric or similar). In situations where insufficient clearance exists between the housing and the implant, this soft, resilient material is capable of providing some cushioning effects, and reducing the harsh effects of metal-to-metal contact between the housing and the head of the implant. In some embodiments, a portion of the housing of the present disclosure can be made of a polymeric resilient material. Advantageously, such use of the polymeric resilient material, for example, can allow a portion of the housing of the present disclosure to be easily machined in-situ to create additional geometric clearance between the implant and housing. The term “in-situ” as used in this disclosure with respect to machining generally refers to the capability of a housing to be machined in place without the need to remove the housing from the denture. This can avoid the need for a more complex and expensive removal and re-installation of the housing into the denture, which is typically required when the housing and the head of the implant come into contact because of a denture/implant system shift (due, for example, to movement of the implants in the patient's jaw). In some embodiments, the polymeric resilient material can include, but is not limited to a polymer such as polypropylene, polyetheretherkeytone (PEEK),polyethylene, polyamide (Nylon), polyoxymethylene (Acetal/Delrin), acrylonitrile butadiene styrene (ABS), high impact polystyrene (HIPS), polyetherimide (PEI/“Ultem”), polybutylene terephalate (PBT), polysulfone (PSO), polyphenylsulfone (PPSU), polyamide-imide (PAI), or other similar compounds. The specific identity of the polymeric material is not critical as long as the material is capable of being machined using conventional techniques.

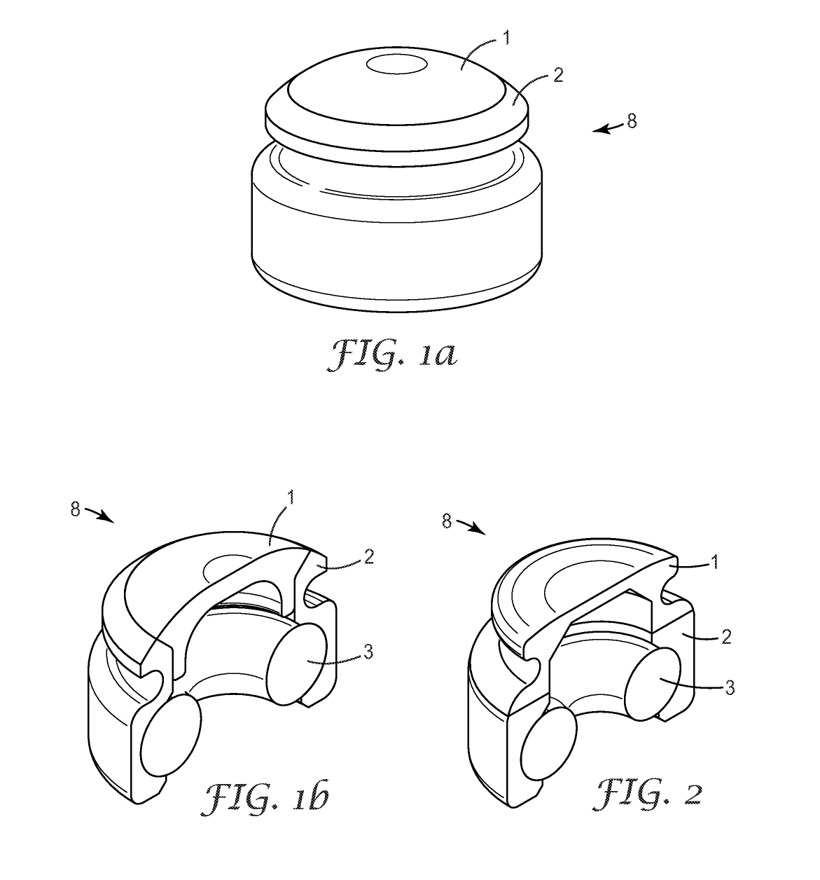

FIGS. 1a and 1b show two views of the housing. FIG. 1a shows a perspective view of the housing and FIG. 1b shows a cross-section view of the housing. In one embodiment, the material such as polypropylene. In some embodiments, the housing can include an upper portion 1 and a metal lower portion 2 adapted to retain a retentive insert. In some embodiments, the upper portion of the housing can be made of the polymeric material and can be machined in-situ. In some embodiments, the upper portion can be machined in-situ to create additional clearance in the housing to seat the dental implant. In some embodiments, the metal of the metal lower portion can be titanium. In this embodiment, the relative proportions of the metal lower portion and the upper portion are not critical as long as, if contact were to occur between the housing and a dental implant, the upper portion of dental implant would contact the upper portion of the housing and not the lower portion.

In some embodiments, the housing can further include a removable retentive insert 3 made from an elastomeric material such as a nitrile, a silicone, an ethylene-propylene-diene monomer (EPDM) material or other similarly suitable materials. In some embodiments, the retentive insert can be removably retained in the metal lower portion of the housing. In other embodiments, the dental implant can be a mini dental implant. In some embodiments, the housing can include an annular groove defined at least partially by the metal lower portion and the annular groove can seat the retentive insert. The retentive insert can be any structure adapted to retain a dental implant such that the dental prosthetic device affixed to the housing is ultimately maintained in place in the patient's jaw. In some embodiments, the retentive insert can be an O-ring.

FIG. 2 illustrates a housing 8 according to one embodiment of the present disclosure. As shown in FIG. 2, in some embodiments, only the portion 2 that retains the retentive insert 3 is metal.

In one embodiment, a kit is described. The kit can generally include the housing of the present disclosure and a dental implant. The dental implant can be removably attached to the housing.

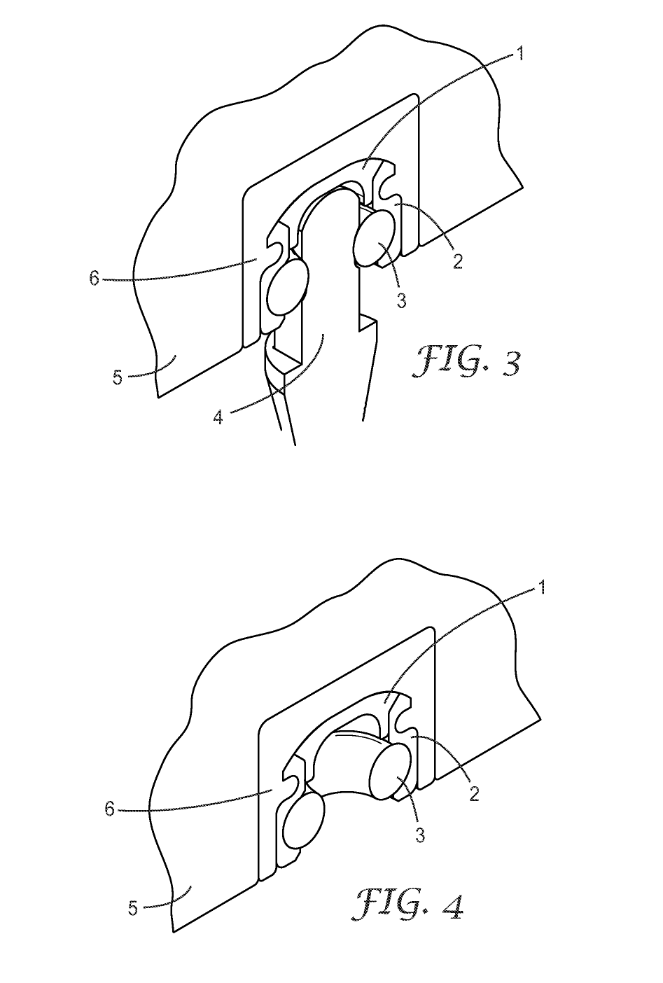

In one embodiment, a dental appliance is described. The dental appliance can generally include the housing of the present disclosure and a denture. FIG. 3 shows a cross-sectional view of the housing in a denture 5 after the “pick-up” procedure with a reline material 6. In some embodiments, the housing can be fixed to the denture. In some embodiments, after sufficient cure time, the housing can be permanently fixed to the denture 5. In properly one embodiment, contact may be only between the o-ring and the implant and between the o-ring and the housing.

FIG. 4 shows the denture assembly upon removal from the dental implant. The housing and the retentive insert stay in the denture. The implant stays in the patient's jaw (not shown).

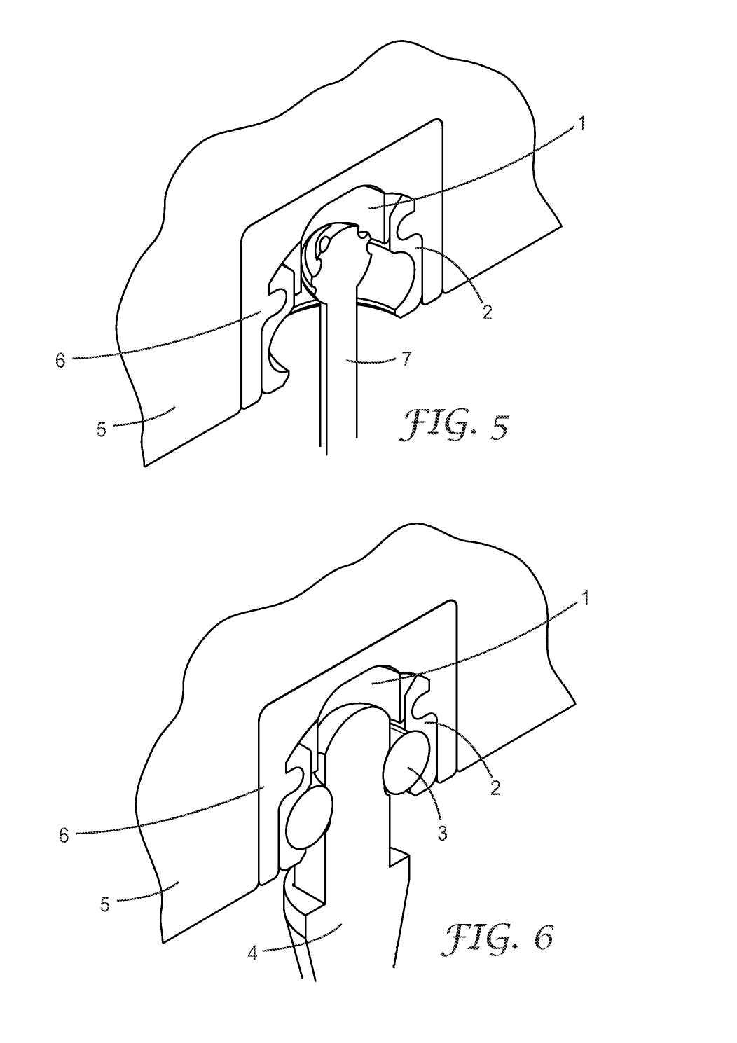

In some cases, bone re-sorption and/or other factors may result in a lack of geometric clearance between the implant and the housing. In these cases, the soft polymeric material of the upper portion of the housing is advantageous because it can provide some cushioning effect and prevent metal to metal contact between the housing and the head (e.g. an O-ball) of the dental implant. A further advantage of the soft polymeric material is illustrated in FIG. 5, which shows how a dental bur 7 can be used to machine out a portion of the housing in-situ. Note that the retentive insert is typically temporarily removed during this machining operation. After machining away the plastic material, the denture is cleaned up and the retentive insert is re-installed. FIG. 6 shows the resulting additional clearance between the head of the implant and the housing.

In some embodiments, a method of retrofitting a housing for a dental implant is provided. The method can include using a dental tool to machine out a portion of the housing of the present disclosure. In some embodiments, using a dental tool to machine out a portion of the housing can include using the dental tool to machine out the polymeric upper portion of the housing. In some embodiments, the method can further include removing the retentive insert from the housing.

In some embodiments, the housing may be made entirely of polymeric material and the advantageous features of the soft polymeric material (cushioning and machinable) can be achieved with a monolithic polymeric housing. However, a housing made entirely of the polymeric material may not have sufficient structural strength and durability. The housings have some very thin wall sections to minimize the overall size. Thicker walls might enable the use of plastic, but the housing would need to be larger and this might not be aesthetically desirable. Smaller housings are typically preferred by dentists when retrofitting a denture. The selective combination of a high-strength metal and a soft polymeric material as described and shown herein have been found to be advantageous.

There are several embodiments of the metal/polymeric housing. Related to these
Machining
Molding
Assembly:
   Heat shrink
   Press fit
   Adhesive
   Welding: ultrasonic, friction

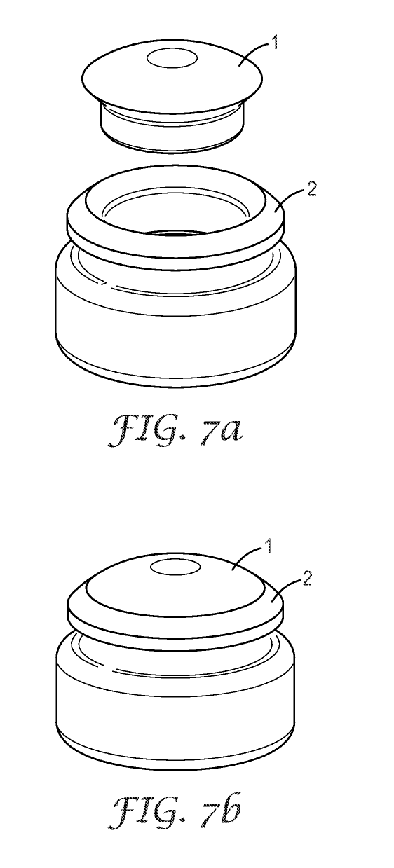

In some embodiments, a method of manufacturing a housing for a dental implant is described. The method can include providing an upper portion made of a polymeric material; providing a metal lower portion of the housing; and affixing the polymeric material upper portion to the metal lower portion. In one embodiment, manufacturing sequence would have the metal portion machined on a lathe. In some embodiments, the upper portion can be injection molded. An assembly process is then performed to combine the two components as shown in FIGS. 7a and 7b.

Other manufacturing processes/sequences can be envisioned, such as over molding, insert molding, or the use of a heat shrink material to encapsulate a topless metal housing.

The following embodiments are intended to be illustrative of the present disclosure and not limiting.

### EMBODIMENTS

Embodiment 1 is a housing for a dental implant comprising:

an upper portion; and

a metal lower portion adapted to retain a retentive insert;

wherein the upper portion is made of a polymeric material, and

wherein the upper portion is capable of being machined in-situ.

Embodiment 2 is the housing of embodiment 1, further comprising of a retentive insert adapted to be removably retained in the metal lower portion.

Embodiment 3 is a kit comprising:

the housing of embodiment 1; and

a dental implant;

wherein the dental implant is adapted to be removably attached to the housing.

Embodiment 4 is a dental appliance comprising: the housing of embodiment 1 and a denture.

Embodiment 5 is the dental appliance of embodiment 4, wherein the housing is fixed to the denture.

Embodiment 6 is the dental appliance of embodiment 5, wherein the housing is permanently fixed to the denture.

Embodiment 7 is the housing, kit or dental appliance of any preceding embodiments, wherein the upper portion is capable of being machined in-situ to create additional clearance in the housing to seat the dental implant.

Embodiment 8 is the housing, kit or dental appliance of any preceding embodiments, wherein the dental implant is a mini dental implant.

Embodiment 9 is the housing, kit or dental appliance of any preceding embodiments, wherein the housing comprises an annular groove defined at least partially by the metal lower portion and the annular groove is adapted to seat the retentive insert.

Embodiment 10 is the housing, kit or dental appliance of any preceding embodiments, wherein the retentive insert is made of a nitrile material, a silicone material, an ethylene-propylene-diene monomer (EPDM) material or a combination thereof.

Embodiment 11 is the housing, kit or dental appliance of any preceding embodiments, wherein the retentive insert is an O-ring.

Embodiment 12 is the housing, kit or dental appliance of any preceding embodiments, wherein the metal of the metal lower portion is titanium.

Embodiment 13 is the housing, kit or dental appliance of any preceding embodiments, (PEEK), polyethylene, polyamide (Nylon), polyoxymethylene (Acetal/Delrin), acrylonitrile butadiene styrene (ABS), high impact polystyrene (HIPS), polyetherimide (PEI/“Ultem”), polybutylene terephalate (PBT), polysulfone (PSO), polyphenylsulfone (PPSU), polyamide-imide (PAI), and combinations thereof.

Embodiment 14 is the housing, kit or dental appliance of any preceding embodiments, wherein the upper portion is injection molded.

Embodiment 15 is a method of manufacturing a housing for a dental implant comprising:

providing an upper portion made of a polymeric material;

providing a metal lower portion of the housing; and

affixing the upper portion to the metal lower portion.

Embodiment 16 is a method of retrofitting a housing for a dental implant, wherein the housing comprises an upper portion and a metal lower portion adapted to retain a retentive insert, the method comprising:

using a dental tool to machine out a portion of the housing.

Embodiment 17 is the method of embodiment 16, wherein the upper portion is made of a polymeric material.

Embodiment 18 is the method of embodiment 17, wherein using a dental tool to machine out a portion of the housing comprises using the dental tool to machine out the polymeric upper portion of the housing.

Embodiment 19 is the method of any of embodiments 16-18, wherein the housing further comprises a retentive insert adapted to be removably retained in the metal lower portion.

Embodiment 20 is the method of embodiment 19, wherein the method further comprises removing the retentive insert from the housing.

The embodiments described above and illustrated in the figures are presented by way of example only and are not intended as a limitation upon the concepts and principles of the present disclosure. As such it will be appreciated by one having ordinary skill in the art that various changes in the elements and their configuration and arrangement are possible without departing from the spirit and scope of the present disclosure.

All references and publications cited herein are expressly incorporated herein by reference in their entirety into this disclosure.

Various features and aspects of the present disclosure are set forth in the following claims.

1. A housing for a dental implant comprising:
an upper portion; and
a metal lower portion adapted to retain a retentive insert;
wherein the upper portion is made of a polymeric material, and
wherein the upper portion is capable of being machined in-situ.

2. The housing of claim 1, further comprising of a retentive insert adapted to be removably retained in the metal lower portion.

3. A kit comprising:
the housing of claim 1; and
a dental implant;
wherein the dental implant is adapted to be removably attached to the housing.

4. A dental appliance comprising: the housing of claim 1 and a denture.

5. The dental appliance of claim 4, wherein the housing is fixed to the denture.

6. The dental appliance of claim 5, wherein the housing is permanently fixed to the denture.

7. The housing, kit or dental appliance of claim 1, wherein the upper portion is capable of being machined in-situ to create additional clearance in the housing to seat the dental implant.

8. The housing, kit or dental appliance of claim 1, wherein the dental implant is a mini dental implant.

9. The housing, kit or dental appliance of claim 1, wherein the housing comprises an annular groove defined at least partially by the metal lower portion and the annular groove is adapted to seat the retentive insert.

10. The housing, kit or dental appliance of claim 1, wherein the retentive insert is made of a nitrile material, a silicone material, an ethylene-propylene-diene monomer (EPDM) material or a combination thereof.

11. The housing, kit or dental appliance of claim 1, wherein the retentive insert is an O-ring.

12. The housing, kit or dental appliance of claim 1, wherein the metal of the metal lower portion is titanium.

13. The housing, kit or dental appliance of claim 1, wherein the polymeric material is selected from polypropylene, polyetheretherkeytone (PEEK), polyethylene, polyamide (Nylon), polyoxymethylene (Acetal/Delrin), acrylonitrile butadiene styrene (ABS), high impact polystyrene (HIPS), polyetherimide (PEI/“Ultem”), polybutylene terephalate (PBT), polysulfone (PSO), polyphenylsulfone (PPSU), polyamide-imide (PAI), and combinations thereof.

14. The housing, kit or dental appliance of claim 1, wherein the upper portion is injection molded.

15. A method of manufacturing a housing for a dental implant comprising:
providing an upper portion made of a polymeric material;
providing a metal lower portion of the housing; and
affixing the upper portion to the metal lower portion.

16. A method of retrofitting a housing for a dental implant, wherein the housing comprises
an upper portion and a metal lower portion adapted to retain a retentive insert, the method comprising:
using a dental tool to machine out a portion of the housing.

17. The method of claim 16, wherein the upper portion is made of a polymeric material.

18. The method of claim 17, wherein using a dental tool to machine out a portion of the housing comprises using the dental tool to machine out the polymeric upper portion of the housing.

19. The method of claim 16, wherein the housing further comprises a retentive insert adapted to be removably retained in the metal lower portion.

20. The method of claim 19, wherein the method further comprises removing the retentive insert from the housing.
